(19) United States
(12) Patent Application Publication
(10) Pub. No.: US 2023/0298333 A1
(43) Pub. Date: Sep. 21, 2023

(54) INFORMATION PROCESSING SYSTEM

(71) Applicant: Humanome Lab., Inc., Tokyo (JP)

(72) Inventor: Jun SESE, Tokyo (JP)

(21) Appl. No.: 18/014,869

(22) PCT Filed: Jul. 7, 2021
(86) PCT No.: PCT/JP2021/025668

§ 371 Date: Jan. 6, 2023

(30) Foreign Application Priority Data
Jul. 8, 2020 (JP) 2020-117757

(51) Int. Cl. G06V 10/82

(52) U.S. Cl. CPC G06V 10/82

(57) ABSTRACT

A technique that enables a trained model to efficiently train is provided. An information processing system includes a trained model providing portion that provides a trained model trained by machine learning using first data of a first user, an input portion that receives input of second data of a second user having purchased the trained model, and an update portion that updates the trained model by machine learning using the second data.

### TECHNICAL FIELD

The present invention relates to an information processing system.

### BACKGROUND ART

A system that provides a pre-trained model has been proposed (see, for example, Patent Literature 1).

### CITATION LIST

### Patent Literature

Patent Literature 1: JP 6695534B1

### SUMMARY OF INVENTION

### Technical Problem

However, there is a possibility that the accuracy desired by the user is not secured by the pre-trained model.

The present invention has been made in view of such a background, and an object thereof is to provide a technique capable of enabling effectively training a trained model.

### Solution to Problem

A main invention of the present invention for solving the problem described above is an information processing system including a trained model providing portion that provides a trained model trained by machine learning using first data of a first user, an input portion that receives input of second data of a second user having purchased the trained model, and an update portion that updates the trained model by machine learning using the second data.

Other problems disclosed in the present application and methods for solving the problems will be clarified by the sections and drawings of the embodiments of the invention.

### Advantageous Effects of Invention

According to the present invention, it is possible to provide a technique capable of enabling effectively train a trained model.

### BRIEF DESCRIPTION OF DRAWINGS

FIG. 1 is a diagram illustrating an overall configuration example of an AI system according to an embodiment of the present invention.

FIG. 2 is a diagram illustrating a hardware configuration example of a management server 2.

FIG. 3 is a diagram illustrating a software configuration example of a management server 2.

FIG. 4 is a diagram illustrating an example of an input screen 11 for annotation data.

FIG. 5 is a diagram for describing a flow of processing of providing a trained model by a provider.

FIG. 6 is a diagram for describing a flow of processing of tuning a trained model by a user.

FIG. 7 is a diagram for describing a flow of prediction processing.

### DESCRIPTION OF EMBODIMENTS

### Summary of Invention

The contents of the embodiments of the present invention will be listed and described. The present invention has, for example, the following configurations.

### [Item 1]

An information processing system including:
a trained model providing portion that provides a trained model trained by machine learning using first data of a first user;
an input portion that receives input of second data of a second user having purchased the trained model; and
an update portion that updates the trained model by machine learning using the second data.

### [Item 2]

The information processing system according to Item 1, further including:

a parameter setting portion that receives setting of a parameter from the second user for the trained model.

### [Item 3]

The information processing system according to Item 1 or 2, in which
the first and second data are image data,
the trained model is a classifier,
the information processing system further includes:
a trained model storage portion that stores a plurality of the trained models; and
a prediction trial portion that acquires reliability in a case where the received second data is given to the trained model, and
the trained model providing portion presents the trained model to the second user in accordance with the reliability, receives designation of the trained model from the second user, and provides the designated trained model.

### [Item 4]

The information processing system according to any one of Items 1 to 3, further including:

a prediction portion that receives input of third data, and performs prediction by applying the received third data to the updated trained model.

### [Item 5]

The information processing system according to Item 3, further including:

a charging processing portion that charges the second user in accordance with execution of the prediction using the third data.

### Summary of System

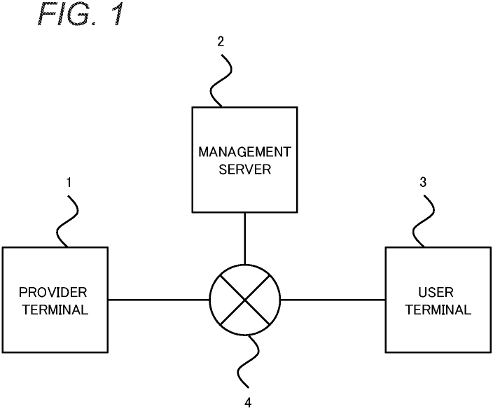

FIG. 1 is a diagram illustrating an overall configuration example of an AI system according to an embodiment of the present invention. The AI system of the present embodiment includes a management server 2. The management server 2 is communicably connected to each of a provider terminal 1 and a user terminal 3 via a communication network 4. The communication network 4 is, for example, the Internet, and is constituted by a public telephone network, a mobile telephone network, a wireless communication path, Ethernet (registered trademark), or the like.

The AI system of the present embodiment is intended to allow a provider to provide a trained model and allow a user to tune and then use the trained model. There may be a large number of providers and users, respectively. In the present embodiment, although the trained model is a classifier that identifies a specific object included in an image, and the classifier is assumed to be Faster RCNN, Mask RCNN, or the like using a neural network having a multilayer structure (deep learning), this is not limiting, and a support vector machine, a random forest, XGBOOST, or the like may be used. Furthermore, in the present embodiment, tuning can be performed by giving an image of another object to a trained model that has learned an image of a certain object and causing the trained model to perform further training. For example, a trained model of Citrus unshiu can be tuned as an orange classifier by giving an orange image to the trained model. By using the trained model having learned the image of the Citrus unshiu, it is possible to efficiently create a highly accurate orange classifier with a small number of images by using a similar but different orange image.

The provider terminal 1 is a computer operated by the provider, and is, for example, a personal computer, a smartphone, a tablet computer, or the like. The provider terminal 1 may be a virtual computer implemented by cloud computing. The provider registers a trained model in a management server 2 using the provider terminal 1. In the present embodiment, the provider can access the management server 2 by operating the provider terminal 1 and register a trained model described using TensorFlow (registered trademark) or the like. In addition, image data (for example, an image of Citrus unshiu) serving as input data to the trained model can be uploaded from the provider terminal 1 to the management server 2, annotation for specifying a region representing an object (for example, Citrus unshiu) to be classified can be performed for each image, the trained model can be updated by giving the region specified by the annotation and the image data to the trained model, and training for extracting an object (for example, Citrus unshiu) from the image data can be performed. Note that the training processing may be performed by a computer other than the management server 2 (for example, the provider terminal 1), and the pre-trained model may be uploaded to the management server 2 together with parameters.

The user terminal 3 is a computer operated by a user who intends to use a pre-trained model. The user terminal 3 is, for example, a personal computer, a smartphone, a tablet computer, or the like. The user terminal 3 may be a virtual computer implemented by cloud computing. The user can perform tuning (for example, creating an orange classifier.) by operating the user terminal 3 to access the management server 2, purchasing a pre-trained model trained by the provider, giving image data (for example, an orange image) of the user to the purchased trained model (for example, a Citrus unshiu classifier), and causing the purchased trained model to perform further learning. In addition, the user terminal 3 can extract and classify an orange from an image by using the trained model (for example, an orange classifier) tuned with the image of the user.

### Management Server

The management server 2 is a computer that performs training processing of a trained model and prediction (classification) processing using the trained model. The management server 2 may be a general-purpose computer such as a workstation or a personal computer, or may be logically realized by cloud computing.

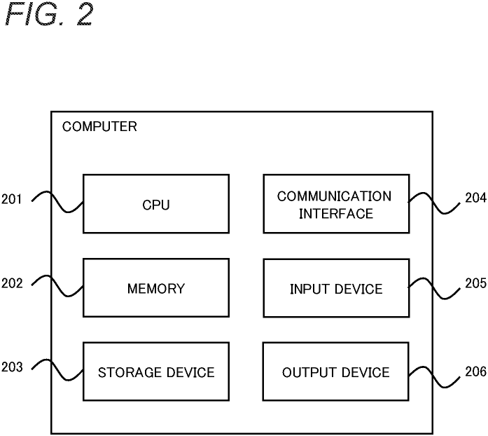

FIG. 2 is a diagram illustrating a hardware configuration example of the management server 2. Note that the illustrated configuration is an example, and other configurations may be employed. The management server 2 includes a CPU 201, a memory 202, a storage device 203, a communication interface 204, an input device 205, and an output device 206. The storage device 203 is, for example, a hard disk drive, a solid state drive, a flash memory, or the like that stores various data and programs. The communication interface 204 is an interface for connection to the communication network 4, and is, for example, an adapter for connection to Ethernet (registered trademark), a modem for connection to a public telephone line network, a wireless communication device for wireless communication, a universal serial bus (USB) connector or an RS232C connector for serial communication, or the like. The input device 205 is, for example, a keyboard, a mouse, a touch panel, a button, a microphone, or the like to input data. The output device 206 is, for example, a display, a printer, a loudspeaker, or the like that outputs data. Each functional portion included in the management server 3 to be described later is realized, for example, by the CPU 201 reading a program stored in the storage device 203 into the memory 202 and executing the program, and each storage portion included in the management server 3 is realized as a part of the storage area provided by the memory 202 and the storage device 203.

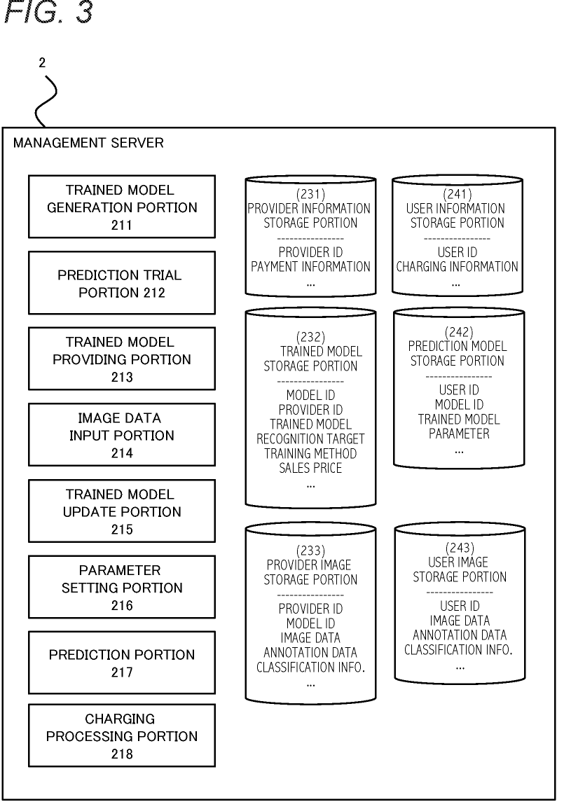

FIG. 3 is a diagram illustrating a software configuration example of the management server 2. The management server 2 includes a provider information storage portion 231, a trained model storage portion 232, a provider image storage portion 233, a user information storage portion 241, a prediction model storage portion 242, a user image storage portion 243, a trained model generation portion 211, a prediction trial portion 212, a trained model providing portion 213, an image data input portion 214, a trained model update portion 215, a parameter setting portion 216, a prediction portion 217, and a charging processing portion 218.

The provider information storage portion 231 stores information regarding the provider (hereinafter, referred to as provider information). As illustrated in FIG. 3, the provider information can include payment information in association with a provider ID for specifying a provider. In the present embodiment, the pre-trained model provided by the provider is sold to the user. The payment information is information for paying sales revenue of the pre-trained model to the provider, and can be, for example, information regarding a bank account.

The trained model storage portion 232 stores information (hereinafter, referred to as model information.) including the trained model provided from the provider. As illustrated in FIG. 3, the model information can include, in association with a model ID specifying a trained model, a provider ID indicating a provider who has provided the trained model, a trained model, a recognition target of the trained model, a training method, a sales price, and the like. As described above, in the present embodiment, it is assumed that the data used for training is image data and the trained model is a classifier. The trained model storage portion 232 can store model information related to a plurality of trained models provided from a plurality of providers.

The provider image storage portion 233 stores information (hereinafter referred to as provider image information) including image data from a provider used for training of the trained model. As illustrated in FIG. 3, the provider image information can include, image data, annotation data indicating a region in which a recognition target is displayed in the image data, and classification information indicating a classification of the recognition target, in association with a provider ID indicating a provider of the image data and a model ID specifying a trained model, in association with a provider ID indicating the provider of the image data and a model ID specifying the trained model. Note that the provider image information can include other information regarding the provider and the image data.

The user information storage portion 241 stores information regarding the user (hereinafter, referred to as user information). As illustrated in FIG. 3, the user information can include charging information in association with a user ID for specifying a user. The charging information is information used for charging a reward in a case where a user purchases a trained model or a charge in a case where prediction processing is performed by using the trained model as will be described later, and can be, for example, a credit card number or authentication information.

The prediction model storage portion 242 stores information (hereinafter, referred to as prediction model information) regarding a trained model used for prediction. The trained model used for prediction is obtained by training a trained model provided by a provider, using an image of the user. That is, the trained model is a trained model obtained by tuning the pre-trained model provided by the provider (trained model trained with the image of the provider), by using the image of the user. For example, a trained model having learned an image of Citrus unshiu is tuned from an orange classifier by further learning images of Citrus unshiu. The prediction model information can include the trained model and parameters in association with the user ID indicating the user and the model ID indicating the trained model purchased by the user. The parameters may be parameters of the trained model or hyperparameters.

The user image storage portion 243 stores information (hereinafter referred to as user image information) including image data from the user. As illustrated in FIG. 3, the user image information can include image data, annotation data, and classification information in association with a user ID indicating a user who has provided the image data.

The trained model generation portion 211 generates a trained model to be provided to the user. In the present embodiment, the trained model generation portion 211 can receive the trained model transmitted from the provider terminal 1 and register the trained model in the trained model storage portion 232. The trained model generation portion 211 can also perform training processing of the trained model provided from the provider. The trained model generation portion 211 can receive a plurality of pieces of image data to be used for training from the provider terminal 1, and for each of the pieces of image data, generate provider image information and register the provider image information in the provider image storage portion 233. Note that the trained model generation portion 211 may acquire the image data not from the provider terminal 1.

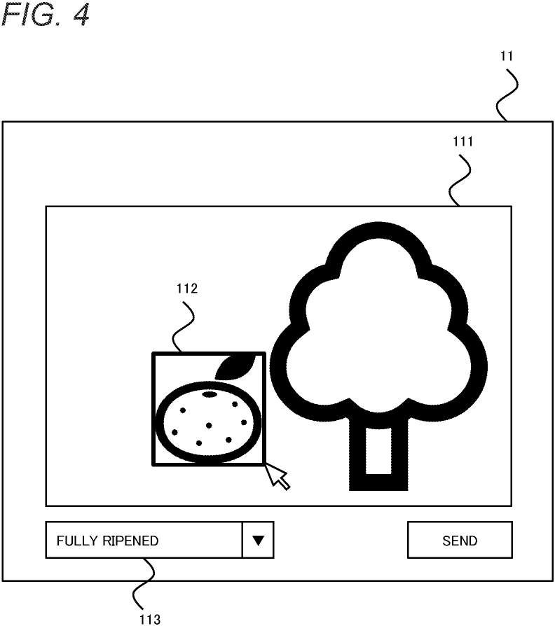

The trained model generation portion 211 can further display image data on the provider terminal 1, receive input of annotation data indicating a region representing a recognition target displayed on the image and classification information, acquire the annotation data and the classification information from the provider terminal 1, and update the provider image information corresponding to the image data. FIG. 4 is a diagram illustrating an example of an input screen 11 for the annotation data. The trained model generation portion 211 can transmit screen data for displaying the screen 11 to the provider terminal 1 and cause the provider terminal 1 to display the screen 11. In addition, the provider terminal 1 receives designation of a region 112 in image data 111 in which the recognition target (Citrus unshiu in the example of FIG. 4) is displayed, and transmits annotation data indicating the region 112 to the management server 2. In addition, the provider terminal 1 can receive an input of classification information 113 indicating the classification (for example, fully ripened, immature, or the like) of the recognition target (Citrus unshiu) and transmit the classification information 113 to the management server 2 together with the annotation data. Note that although the region 112 is specified by a rectangle in the example of FIG. 4, a region of an arbitrary shape such as a circle, a polygon, or a free curve can be used as the annotation data.

In addition, the learning model generation portion 211 can provide the image data 111, the annotation data 112, and the classification information 113 to cause the trained model to learn. Note that general machine learning processing can be used for the training processing of the trained model (parameter update processing of the trained model).

The prediction trial portion 212 performs a trial of prediction (classification) using the image received from the user. The prediction trial portion 212 can receive one or a plurality of pieces of image data from the user terminal 3, apply the received image data to the trained model, and acquire a prediction result (classification) and reliability thereof. The prediction trial portion 212 may receive designation of a trained model to be used for the trial of prediction, or may select some or all trained models stored in the trained model storage portion 232 and perform prediction.

The trained model providing portion 213 provides the user with a trained model trained by machine learning using the image data of the provider. The trained model providing portion 213 can transmit the trained model to the user terminal 3 according to the reliability of the prediction result tried by the prediction trial portion 212. For example, the trained model providing portion 213 may transmit the prediction result and the reliability from the prediction trial portion 212 to the user terminal 3 together with the recognition target, the training method, and the sales price of the trained model. The user can select the trained model to be purchased, by using the prediction result by the prediction trial portion 212 and/or with reference to the recognition target, the trained method, the sales price, and the like. The trained model providing portion 213 can also receive designation of a trained model from the user terminal 3 and sell the designated trained model to the user. For the sales processing to the user, a method by general online shopping or the like can be used.

The image data input portion 214 receives an input of image data from the user who has purchased the trained model. The image data input portion 214 can receive image data from the user terminal 3, create user image information including the received image data, and register the user image information in the user image storage portion 243.

The image data input portion 214 can also receive an input of annotation data and classification information from the user. Similarly to the trained model generation portion 211 described above, the screen 11 illustrated in FIG. 4 is displayed on the user terminal 1, the annotation data indicating the region 112 in the image data 111 and the classification information 113 are acquired, and the user image information corresponding to the image data can be updated with the acquired annotation data and classification information.

The learning model update portion 215 updates the trained model by machine learning using the image data (image data of the user image information) provided by the user. The trained model update portion 215 can update the trained model by giving the image data, the annotation data, and the classification information of the user image information corresponding to the user to the trained model of the prediction model information corresponding to the user. The update of the trained model is also referred to as tuning.

The parameter setting portion 216 receives setting of parameters for the trained model from the user. The parameters can include, for example, hyperparameters such as a learning rate, the number of steps, whether early stopping is to be performed, a threshold value for certification of an object (a value with accuracy equal to or greater than this value can be certified as “present”), and the like.

The prediction portion 217 performs prediction processing using the tuned trained model (trained model registered in the prediction model storage portion 242). The prediction portion 217 can receive an input of the image data from the user terminal 3 and perform prediction (classification of the recognition target) by giving the received image data to the trained model corresponding to the user.

The charging processing portion 218 charges the user according to the execution of the prediction processing by the prediction portion 217. For example, the charging processing portion 218 may charge the user with a fixed usage fee, or may charge the user with an amount-dependent usage fee corresponding to the number of times of execution of the prediction processing, the size of the image data, or the like. Note that, in a case where the prediction processing is performed in response to an input of an image from a user other than the user, the other user may be charged instead of the user corresponding to the trained model.

### Operation

Hereinafter, the operation of the AI system of the present embodiment will be described.

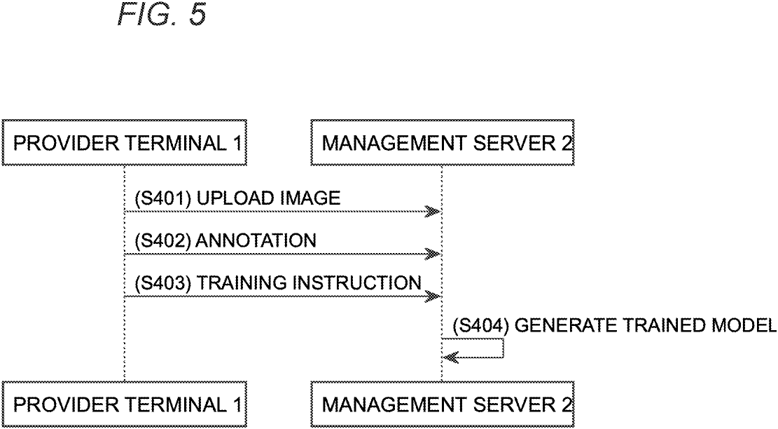

FIG. 5 is a diagram illustrating a flow of providing processing of a trained model by a provider.

The provider terminal 1 uploads the image data from the provider to the management server 2 (S401), receives the input of the annotation data and the classification information by displaying the screen 11 illustrated in FIG. 4, and transmits the received annotation data and classification information to the management server 2 (S402). The provider terminal 1 transmits a training instruction to the management server 2 (S403), and the management server 2 performs training of the trained model using the image data, the annotation data, and the classification information (S404). In this manner, the trained model trained by the provider is registered in the management server 2.

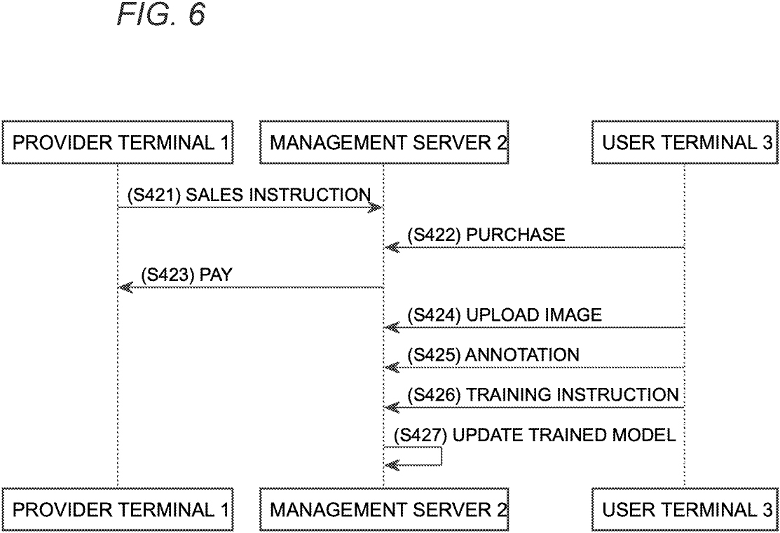

FIG. 6 is a diagram for describing a flow of processing in which the user tunes the trained model.

The provider terminal 1 issues a sales instruction for the pre-trained model (S421), and the management server 2 can manage the instructed trained model to be sellable to the user. The user terminal 3 purchases the trained model from the management server 2 (S422), and the management server 2 pays the provider a fee corresponding to the purchase (S423).

The user terminal 3 uploads the image data of the user to the management server 2 (S424), receives the input of the annotation data and the classification information by displaying the screen 11 illustrated in FIG. 4, and transmits the received annotation data and classification information to the management server 2 (S425). When the instruction of training is transmitted from the user terminal 3 to the management server 2 (S426), the management server 2 performs additional training of the trained model using the image data, the annotation data, and the classification information received from the user terminal 3 (S427). As a result, the trained model trained by the provider is additionally caused to perform training with the image data from the user, and tuning can be performed so as to accurately perform classification according to the use of the user.

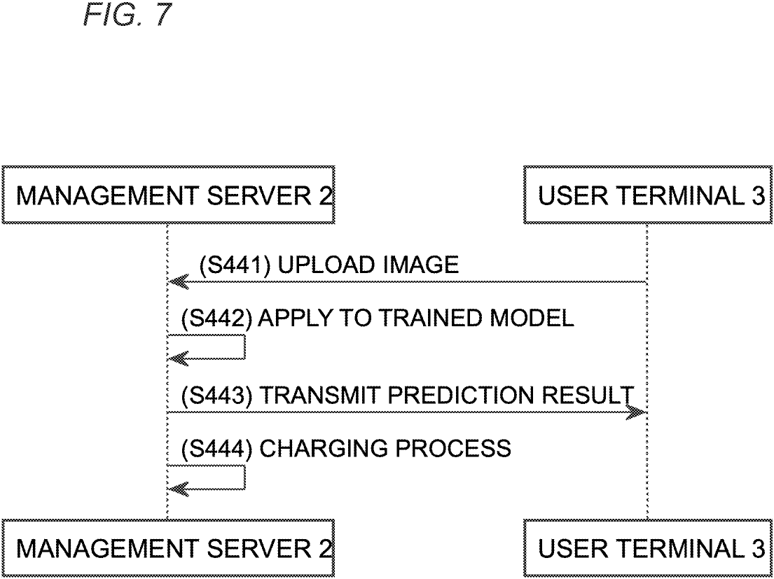

FIG. 7 is a diagram illustrating a flow of prediction processing. When the image data is transmitted from the user terminal 3 to the management server 2 (S441), the management server 2 can read the trained model corresponding to the user ID from the prediction model storage portion 242, and obtain the classification information by applying the image data to the read trained model (S442). The management server 2 transmits the prediction result (classification information) to the user terminal 3 (S443). In addition, the management server 2 can perform a charging process for the user according to the prediction processing (S444).

As described above, according to the AI system of the present embodiment, the trained model trained by the provider can be additionally subjected to training with the image of the user, so that the trained model can be used for prediction after being tuned for a target that the user wants to recognize. Therefore, the user can perform training even if the data amount is small, the cost for training can be reduced, and the time required for training can be reduced. For example, in a case where additional training related to a similar image is performed, as in a case where a trained model obtained by tuning, for an early tangerine and with an image of an early tangerine, a trained model having learned an image of Citrus unshiu is created, the learning rate can be set to a small value, convergence is fast, and the number of epochs (the number of steps and the number of learnings) can be small, so that efficient training can be performed.

Furthermore, for the provider, according to the AI system of the present embodiment, the secondary use of the trained model trained by the provider can be promoted. For example, the provider can sell a trained result that is no longer necessary. In addition, the provider can construct the trained model using the management server 2 without performing server management by themself.

Although the present embodiment has been described above, the above embodiment is for facilitating understanding of the present invention, and is not intended to limit the interpretation of the present invention. The present invention can be modified and improved without departing from the gist thereof, and the present invention includes equivalents thereof.

For example, although a case where there are only one provider terminal 1 and one user terminal 3 has been described in the present embodiment, but there may be a plurality of provider terminals 1 and a plurality of user terminals 3.

In addition, although performing, with an image of an orange, the additional training of the trained model having trained an image of Citrus unshiu has been described as an example in the present embodiment, this is not limiting. For example, it is also effective to cause a trained model having learned a crack image of a building to perform additional training with a crack image of a bridge pier, and it is also effective to perform training of atopic dermatitis by using a trained model with an image of skin inflammation or the like, or perform learning of stomach cancer by using a model having learned a colonoscopic image or the like.

In addition, it is also effective to perform additional training with images of different photographing places and different photographing subjects even for the same recognition target. For example, it is also possible to perform tuning for another hospital by performing additional training by giving an image in the other hospital to a trained model having learned an image of a certain hospital.

Furthermore, it has been stated that the model information includes a training method and a sales price in addition to a trained model in the present embodiment, this is not limiting, and the architecture + method, the determination time per image, the image size, the domain of the recognition target, the recognition accuracy (AUC or the like), the number of trained images, the number of annotations, the number of purchases, the creator, the rating of the creator, a review, a sample of a used image, the number of classes, a label name, the format of the image, the registration date, the last update date, and the like can also be included. The user can select the trained model with reference to these pieces of information.

Furthermore, although the prediction portion 217 receives image data from the user and performs prediction in the present embodiment, the prediction may be performed by receiving an input of image data from another user different from the user. In this case, the other user can transmit the image data to the management server 2 together with the designation of the tuned trained model stored in the prediction model storage portion 242, and the prediction 217 can obtain the classification information by giving the received image data to the designated trained model. In this case, the user may be charged, or the other user may be charged.

Furthermore, although the learning model is a classifier that identifies a specific object included in an image in the present embodiment, the trained model is not limited to this, and may be a trained model that receives input data other than image data, or may be a predictor, a generator such as a GAN, a transformer, or the like instead of a classifier. Furthermore, the input data can be, for example, arbitrary data that can be expressed as a feature amount vector. Furthermore, as the input data, for example, data in which a plurality of feature amount vectors are arranged, such as data of spreadsheet software, may be received such that training can be performed for each row (each vector). In this case, a numerical value may be given as the annotation data. Further, instead of the classification information, teacher data indicating a continuous value may be provided.

Furthermore, although the trained model is assumed to be a neural network (deep learning) of a multilayer structure in the present embodiment, this is not limiting, and trained models of various method can be adopted.

Reference Signs List

| | |
|---|---|
| 1 | provider terminal |
| 2 | management server |
| 3 | user terminal |
| 231 | provider information storage portion |
| 232 | trained model storage portion |
| 233 | provider image storage portion |
| 241 | user information storage portion |
| 242 | prediction model storage portion |
| 243 | user image storage portion |
| 211 | trained model generation portion |
| 212 | prediction trial portion |
| 213 | trained model providing portion |
| 214 | image data input portion |
| 215 | trained model update portion |
| 216 | parameter setting portion |
| 217 | prediction portion |
| 218 | charging processing portion |

1. An information processing system comprising:
a trained model providing portion that provides a trained model trained by machine learning using first image data of a first user;
an input portion that receives input of second image data of a second user having purchased the trained model;
an update portion that updates the trained model, which is a classifier, by machine learning using the second image data;
a trained model storage portion that stores a plurality of the trained models; and
a prediction trial portion that acquires reliability in a case where the received second image data is given to the trained model, wherein
the trained model providing portion presents the trained model to the second user in accordance with the reliability, receives designation of the trained model from the second user, and provides the designated trained model.

2. The information processing system according to claim 1, further comprising:
a parameter setting portion that receives setting of a parameter from the second user for the trained model.

3. The information processing system according to claim 1, further comprising:
a prediction portion that receives input of third data, and performs prediction by applying the received third data to the updated trained model.

4. The information processing system according to claim 3, further comprising:
a charging processing portion that charges the second user in accordance with execution of the prediction using the third data.

5-6. (canceled)
